(19) United States
(12) Patent Application Publication
(10) Pub. No.: US 2026/0252085 A1
(43) Pub. Date: Aug. 27, 2026

(54) USING OCR TO DETECT SHELF LABELS AND ASSOCIATING THEM WITH 3D DATA TO USE THEM AS LANDMARKS

(71) Applicant: ATLAS ROBOTICS AND AUTOMATION, INC., Pittsburgh, PA (US)

(72) Inventors: Çetin Alp Meriçli, Pittsburgh, PA (US); Tekin Alp Meriçli, Pittsburgh, PA (US)

(21) Appl. No.: 19/462,192

(22) Filed: Jan. 28, 2026

Related U.S. Application Data
(60) Provisional application No. 63/751,072, filed on Jan. 29, 2025.

(51) Int. Cl. G05D 1/243; G01C 21/00; G05D 1/245; G05D 1/246; G05D 1/69; G06T 7/73; G06V 10/25; G06V 10/75; G06V 10/98; G06V 20/58; G06V 20/62; G06V 20/70; G06V 30/19

(52) U.S. Cl. CPC G05D 1/243; G01C 21/3885; G05D 1/245; G05D 1/2462; G05D 1/69; G06T 7/74; G06V 10/25; G06V 10/75; G06V 10/98; G06V 20/58; G06V 20/63; G06V 20/70; G06V 30/19007; G06T 2207/30261

(57) ABSTRACT

A system and method for autonomous robot localization using text-annotated three-dimensional landmarks in warehouse and industrial environments. A camera captures images containing shelf labels, corridor signs, and other existing textual markers. An OCR module detects and extracts textual content from images. A 3D sensing subsystem captures spatial data using techniques including LIDAR, stereo vision, depth sensors, or monocular depth estimation. A data association module correlates detected text with 3D positions, optionally extracting surface orientation information to constrain robot heading. Detected text, associated 3D positions, and optional surface normals are stored as landmarks in a database. A localization module queries the database to match observed text with known landmarks, computes robot pose from landmark positions, and enables global localization, automatic initialization after reboot, and drift correction. Integration with continuous localization methods provides robust, drift-corrected pose estimation. Multi-robot fleets collaboratively build and maintain shared landmark maps. The system integrates with warehouse management systems by using human-readable label identifiers for task specification.

### CROSS-REFERENCE TO RELATED APPLICATIONS

This application claims the benefit of U.S. Provisional Patent Application No. 63/751,072, filed Jan. 29, 2025, entitled “USING OCR TO DETECT SHELF LABELS AND ASSOCIATING THEM WITH 3D DATA TO USE THEM AS LANDMARKS,” which is incorporated herein by reference in its entirety.

### TECHNICAL FIELD

This disclosure relates generally to computer vision, optical character recognition, and autonomous robotic navigation systems. More particularly, this disclosure relates to systems and methods for detecting textual information on shelf labels, signage, and other environmental markers using optical character recognition (OCR), associating the detected text with three-dimensional (3D) spatial data, and using the resulting text-annotated 3D landmarks for robot localization, navigation, and mapping in indoor environments including warehouses, retail stores, distribution centers, and manufacturing facilities.

### BACKGROUND

### A. Indoor Localization Challenges

Autonomous mobile robots operating in indoor environments face localization and mapping challenges in determining their position and building maps of their surroundings. Unlike outdoor environments where Global Positioning System (GPS) signals provide meter-level position estimates, GPS is generally unavailable or unreliable indoors due to signal attenuation and multipath effects.

Indoor localization systems typically employ one or more of several approaches:

Visual Simultaneous Localization and Mapping (SLAM): Visual SLAM systems use cameras to detect visual features (corners, edges, textures) in the environment. By tracking these features across multiple camera frames and applying geometric constraints, the system simultaneously estimates the robot's trajectory and builds a map of feature locations. While effective, visual SLAM suffers from several limitations: features are anonymous (lacking semantic meaning), tracking can fail in textureless environments or areas with repetitive visual patterns, localization drift accumulates over long distances, and loop closure (recognizing previously visited locations) is unreliable without distinctive visual landmarks.

LIDAR-Based SLAM: LIDAR (Light Detection and Ranging) sensors measure distances to surrounding surfaces by emitting laser pulses and measuring time-of-flight. LIDAR SLAM builds geometric maps of the environment and localizes within these maps. However, LIDAR maps are purely geometric—they represent surfaces and obstacles but contain no semantic information about what objects or locations those surfaces correspond to. This makes it difficult to initialize localization (the “kidnapped robot problem”; that is, determining initial position without prior knowledge) or to recover from localization failures.

Artificial Marker Systems: Some systems deploy artificial markers such as AprilTags, QR codes, or AR markers at known locations. Robots detect these markers and use them for localization. While effective, artificial marker systems require infrastructure installation and maintenance, markers may be damaged or occluded, and deploying markers throughout large facilities is labor-intensive and costly.

Wi-Fi or Radio Fingerprinting: Signal strength measurements from Wi-Fi access points or radio beacons can provide coarse localization. However, accuracy is typically limited to several meters, and performance degrades with changes in the radio environment (moving equipment, people).

### B. Untapped Semantic Information in Indoor Environments

Indoor industrial and retail environments contain abundant semantic information in the form of textual labels, signs, and markers that are installed for human operators but are largely ignored by current robotic localization systems:

Shelf Labels: Warehouses and retail stores use shelf labels to identify storage locations. Labels typically display alphanumeric codes indicating aisle, bay, level, and position (e.g., “A5-3-2” indicating Aisle A5, Bay 3, Level 2). These labels are systematically organized, permanently mounted, and positioned at consistent heights.

Corridor and Aisle Signage: Large warehouses employ overhead signage indicating corridor or aisle identifiers (e.g., large “G” and “F” signs visible in warehouse environments). These signs are highly visible and provide unambiguous location information.

Safety Signage: Exit signs, emergency equipment labels, hazard warnings, and other safety-related signage are mandated by regulations (OSHA in the United States) and are consistently positioned according to standards.

Product Labels and Information: While more variable than location labels, product labels, shelf tags displaying SKUs, and informational signage provide additional semantic anchors.

Despite the ubiquity of this textual information, current robotic systems do not systematically leverage it for localization. If a robot could detect shelf label “A5-3-2”, recognize the text content via OCR, and associate that label with its 3D position, the robot would gain a powerful semantic landmark that enables:

Global Localization: Instantly determining position upon detecting a known label

Localization Initialization: Automatically initializing position after reboot or in a new area

Drift Correction: Correcting accumulated odometry drift by re-observing known labels

Semantic Mapping: Building maps annotated with human-readable location identifiers

Task Integration: Direct correlation between task specifications (“go to location A5-3-2”) and navigation

### C. Limitations of Prior Art

Several patents and publications have addressed aspects of visual landmark detection and OCR-based localization, but none adequately address the comprehensive system described herein.

U.S. Pat. No. 9,080,882 to Gupta et al. (Qualcomm Inc, Jul. 14, 2015) entitled “Visual OCR for Positioning” directly addresses using OCR for positioning. The system uses optical character recognition to identify text and symbols in captured images and converts them into precise location coordinates for mobile phones and handheld devices. The technology employs location-constrained OCR libraries and correlates detected text with position databases using GPS and cellular infrastructure to determine device location. This demonstrates prior art in using text recognition for localization, though it focuses on consumer mobile devices in outdoor environments rather than autonomous warehouse robots, and does not teach association with 3D point cloud data or LIDAR integration for autonomous indoor navigation.

U.S. Pat. No. 9,908,702 to Elazary et al. (Invia Robotics LLC, Mar. 6, 2018) entitled “Robotic Navigation and Mapping” describes robots using multi-resolution visual markers (April tags, ArUco markers, QR codes, barcodes) for navigation without halting movement. The system uses markers for continuous navigation and precise positioning at waypoints. However, this approach relies on artificial markers installed specifically for robot navigation, rather than leveraging existing shelf labels and signage through OCR. It does not teach extracting semantic text content or creating text-annotated 3D landmark maps. Furthermore, the reference teaches toward using specially designed visual markers rather than textual shelf labels, as markers provide more reliable detection than natural text in the warehouse environment.

U.S. Pat. No. 11,380,003 to Chen et al. (Black Sesame Technologies Inc, Jul. 5, 2022) entitled “Monocular Camera Localization in Large Scale Indoor Sparse LIDAR Point Cloud” directly addresses camera-LIDAR integration for localization. The system combines monocular camera imagery with sparse LIDAR point cloud data through iterative depth projection and similarity measurement using neural networks. This demonstrates prior art in fusing camera and LIDAR data for positioning in indoor environments. However, it focuses on geometric alignment and pose estimation using geometric features rather than semantic feature extraction, and does not teach OCR-based text detection, using shelf labels as landmarks, or creating text-annotated 3D maps with semantic content.

U.S. Pat. No. 11,703,334 to Salfity et al. (Hewlett Packard Development Co LP, Jul. 18, 2023) entitled “Mobile Robots to Generate Reference Maps for Localization” describes robots creating reference maps by scanning environments and using semantic segmentation to identify and exclude transient objects, retaining only stable environmental features for reliable navigation. This demonstrates prior art in using semantic analysis to build robot localization maps with permanent features. While relevant to semantic map building and distinguishing stable landmarks, this patent does not teach OCR-based text detection, extracting semantic content from shelf labels and signage, or specifically associating textual information with 3D positions for robot localization.

U.S. Pat. No. 10,259,649 to Raizer (Bionichive Ltd, Apr. 16, 2019) entitled “Automatic Warehouse System” describes warehouse automation with autonomous robots navigating rail networks. The system includes fine positioning sensors that capture images of boxes and employ image processing algorithms to isolate box ID labels and calculate positional corrections. While this demonstrates using label detection for positioning in warehouses, it focuses on rail-mounted robots with constrained movement along fixed tracks rather than free-ranging autonomous mobile robots navigating throughout warehouse or retail spaces. It does not teach OCR-based semantic text extraction or integration with LIDAR/3D point clouds for creating text-annotated landmark maps usable for global localization.

None of these references, individually or in combination, disclose or suggest a system that:-Detects existing shelf labels and environmental signage not installed specifically for robot navigation using OCR-Associates detected text with 3D spatial positions from LIDAR or other 3D sensors through camera-3D sensor calibration Creates text-annotated 3D landmark maps storing textual content with associated three-dimensional positions—Uses text-annotated landmarks for global localization and automatic localization initialization-Dynamically updates text-annotated maps as labels change in warehouse environments—Integrates OCR-based semantic landmarks with other localization methods for drift correction Provides camera-3D sensor calibration using detected labels as calibration targets

### D. Need for Improved Localization Systems

There exists a need for localization systems that leverage the abundant semantic textual information present in industrial environments. Specifically, systems are needed that:

Exploit Existing Infrastructure: Utilize shelf labels and signage already installed for human operators without requiring additional infrastructure or artificial marker deployment

Provide Semantic Landmarks: Create landmarks with human-readable semantic meaning rather than anonymous geometric features, enabling natural task specification

Enable Global Localization: Determine absolute position from single observations without requiring continuous tracking from known starting positions

Support Automatic Initialization: Initialize localization after system reboot or deployment in new areas without human intervention or manual pose specification

Correct Drift: Provide absolute position references to correct accumulated drift in continuous localization systems

Adapt to Changes: Detect when labels change and update maps accordingly to maintain accuracy in dynamic warehouse environments

Integrate with Geometric Sensing: Combine OCR-based semantic landmarks with three-dimensional spatial data for robust, multi-modal localization

The disclosed system addresses these needs through comprehensive integration of OCR, 3D sensing, and localization systems specifically designed for indoor industrial environments where existing textual labels and signage provide rich semantic information.

### SUMMARY

The disclosed system provides methods and systems for detecting textual information on shelf labels and environmental signage using optical character recognition (OCR), associating detected text with three-dimensional spatial data, and using text-annotated landmarks for robot localization, navigation, and mapping without requiring installation of artificial markers.

### Principal Aspects

In one aspect, a localization system mounted on an autonomous mobile robot operating in an indoor warehouse environment comprising shelving structures with text labels includes an imaging subsystem with one or more cameras that capture images of the environment as the robot navigates. An OCR processing module analyzes captured images to detect regions containing text and extract textual content from detected regions, where the textual information comprises existing shelf labels and corridor signage not installed specifically for robot navigation. The OCR module identifies shelf labels, aisle signs, corridor markers, and other textual landmarks in the environment.

In another aspect, a 3D sensing subsystem operates concurrently with the imaging subsystem to acquire three-dimensional spatial data. The 3D sensing subsystem may utilize any technique for capturing three-dimensional information including but not limited to LIDAR, stereo vision, structured light, time-of-flight depth sensing, photogrammetry, monocular depth estimation using machine learning models, or combinations thereof. The 3D sensing subsystem provides three-dimensional coordinates for surfaces and objects in the environment. In embodiments utilizing monocular depth estimation, depth accuracy may be lower than dedicated 3D sensors but can provide adequate performance for landmark localization in controlled indoor environments.

In yet another aspect, a data association module correlates detected textual information with corresponding 3D spatial positions. When the OCR module detects text (e.g., shelf label “A5-3-2”), the data association module determines the 3D position of that text in space. This association is accomplished through camera-3D sensor calibration that establishes geometric correspondence between camera pixels and 3D points, projection of 3D points onto camera images, identification of 3D points corresponding to detected text regions, or depth estimation from camera images directly.

In a further aspect, the system builds and maintains a text-annotated 3D map (landmark map) storing landmark entries. Each landmark entry includes the textual content detected (e.g., “A5-3-2”), the 3D position where that text was observed (x, y, z coordinates in a global reference frame), uncertainty estimates for the position, and optionally the surface orientation (normal vector) of the plane containing the landmark when determinable from 3D data, and additional metadata such as text appearance, observation timestamps, and confidence scores. The landmark map represents a database of semantic anchors distributed throughout the environment.

In an additional aspect, the system uses text-annotated landmarks for localization. When the robot observes a landmark whose text content matches an entry in the landmark map, the system determines the robot's position by geometric transformation from the known landmark position and the observed relative position of the landmark. When the landmark's surface orientation is known (from stored normal vector), single-landmark observations can constrain both position and orientation, reducing pose ambiguity from a circular region to discrete hypotheses or a precise point estimate. This enables global localization, determining the robot's absolute position from a single landmark observation without requiring continuous tracking from a known starting position. This capability is particularly valuable for localization initialization (automatic pose estimation after system startup or reboot), recovery from localization failures (re-localizing after tracking is lost), and drift correction (correcting accumulated odometry errors by re-observing known landmarks).

In another aspect, the system integrates text-annotated landmarks with other localization methods. Continuous localization methods (such as geometric SLAM, visual odometry, or sensor-based tracking) provide high-frequency pose estimation but are subject to drift accumulation. Text-annotated landmarks provide absolute position references but are observed intermittently. By fusing both modalities, the system achieves localization that is both continuous and drift-corrected. The localization framework may incorporate landmark observations to constrain pose estimates and reduce accumulated drift.

In yet another aspect, the system dynamically updates the landmark map. During operation, when the robot detects a text label at a position where no corresponding landmark exists in the map, a new landmark is created. When the robot detects text that matches an existing landmark but at a different position, the system determines whether the observation represents label relocation, a duplicate label at a new location, or a sensor error, and updates the map accordingly. This dynamic updating ensures the map remains accurate as the warehouse layout changes.

In a further aspect, OCR processing employs computational techniques to achieve robust text detection and recognition in challenging conditions. The system may utilize machine learning approaches, pattern matching algorithms, or combinations thereof to localize text regions in images and recognize character sequences. The system may employ existing OCR frameworks, custom-trained models, or hybrid approaches adapted to warehouse labels and signage.

In another aspect, the system implements sensor fusion combining camera images with three-dimensional spatial data and optionally additional sensor modalities. Calibration procedures establish geometric relationships between sensors. Temporal synchronization ensures data from different sensors corresponding to the same moment in time are processed together. The fusion enables accurate association of OCR results with 3D positions.

In an additional aspect, the system supports operation in environments with varying lighting conditions, label types, fonts, sizes, orientations, and states of degradation. Preprocessing algorithms enhance image quality for OCR, including illumination normalization, contrast enhancement, deblurring, and perspective correction. Multi-scale processing detects text at different sizes. Confidence scoring and outlier rejection prevent incorporation of erroneous detections into the landmark map.

In a further aspect, multiple autonomous mobile robots in a fleet share landmark observations to collaboratively build and maintain a shared text-annotated landmark map database. The system includes conflict detection for when different robots observe the same textual content at different positions, statistical fusion algorithms to reconcile measurements, and map synchronization to distribute updated landmark data across the robot fleet.

The disclosed system provides numerous advantages including leveraging existing infrastructure without requiring installation of artificial markers, providing semantic landmarks with human-readable identifiers that facilitate integration with task planning and warehouse management systems, enabling rapid global localization and automatic initialization without prior pose knowledge, correcting drift in geometric localization through absolute position references, adapting to environmental changes by dynamically updating landmark maps, improving overall navigation robustness through multi-modal sensor fusion, reducing deployment costs by eliminating marker infrastructure, and enabling natural task specification using semantic landmark identifiers that match warehouse labeling conventions.

### BRIEF DESCRIPTION OF THE DRAWINGS

The disclosed subject matter will be better understood from the following detailed description taken in conjunction with the accompanying drawings:

FIG. 1 depicts an example warehouse environment with visual landmarks.

FIG. 2 illustrates a system architecture diagram for the OCR-based localization system.

FIG. 3 depicts a flowchart of the landmark detection and localization process.

### DETAILED DESCRIPTION OF PREFERRED EMBODIMENTS

The following detailed description presents preferred embodiments. Modifications apparent to those skilled in the art are within the scope of the disclosure.

### System Overview

### A. Hardware Platform

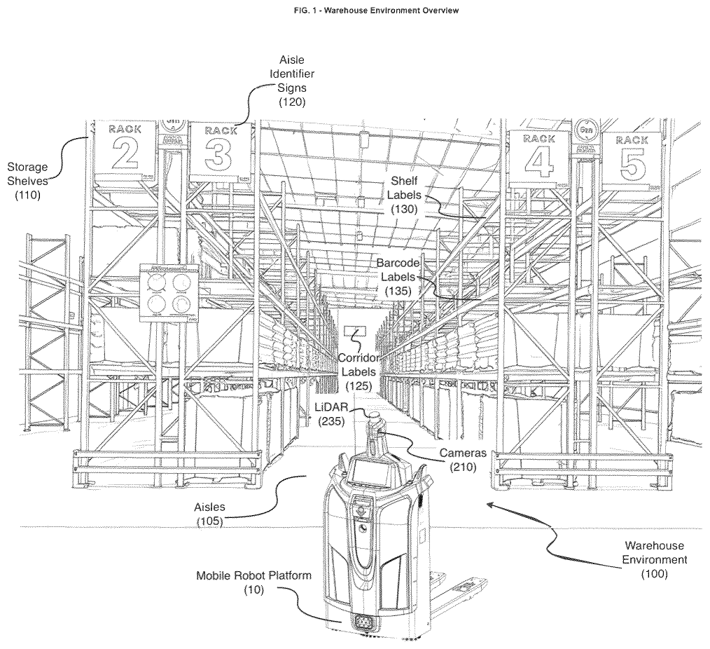

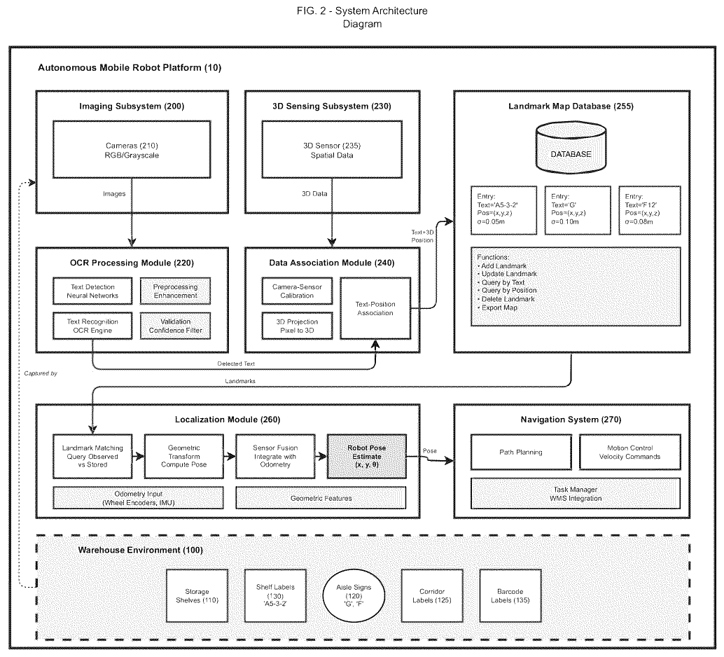

Referring to FIG. 2, the system is implemented on an autonomous mobile robot platform (10) operating in an indoor warehouse environment (100) as shown in FIG. 1. The warehouse environment (100) comprises several structural and informational elements that serve as landmarks for robot navigation:

Aisles (105): Navigation corridors between shelving structures allowing robot movement through the warehouse. Aisles (105) typically have widths ranging from 2 to 5 meters to accommodate robot traffic and material handling operations.

Storage Shelves (110): Vertical shelving structures holding inventory items. Storage shelves (110) provide mounting surfaces for shelf labels (130) and serve as visual and geometric references for localization.

Aisle Identifier Signs (120): Large overhead signs displaying aisle identifiers such as numbers or letters that mark major warehouse corridors. Aisle identifier signs (120) are visible from long distances (15-30 meters) and provide coarse localization information.

Corridor Labels (125): Directional signage indicating warehouse zones or wings, such as “North Wing” or “Receiving Area.” Corridor labels (125) assist in zone-level navigation and task routing.

Shelf Labels (130): Alphanumeric labels affixed to storage shelves (110) identifying specific storage locations with codes such as “A5-3-2” indicating aisle, bay, and level. Shelf labels (130) are the primary landmarks for precise localization, typically positioned at consistent heights (0.5-2.5 meters above ground) and readable at distances of 3-10 meters depending on label size and camera resolution.

Barcode Labels (135): Machine-readable barcodes on shelves or products providing inventory identification. Barcode labels (135) may supplement textual shelf labels (130) and can be detected using the same imaging subsystem (200).

The robot platform (10) includes:

Mobile Base: The mobile robot chassis provides mobility through differential drive, Ackermann steering, omnidirectional wheels, or other mechanisms. The base includes wheel encoders measuring wheel rotations for odometry, providing relative motion estimates.

Imaging Subsystem (200): One or more cameras (210) mounted on the robot capture images of the environment. Preferred configurations include:

Monocular Cameras: Single cameras provide 2D image data for OCR processing. High-resolution cameras (5+megapixels) enable text detection at distances of 3-10 meters depending on label size. Camera specifications typically include resolution of 1920×1080 (Full HD) to 3840×2160 (4K), frame rates of 15-30 fps, and fields of view ranging from narrow (30-50 degrees) for high-resolution distant label reading to wide (80-120 degrees) for broad coverage. When combined with machine learning-based monocular depth estimation, single cameras may provide both imaging and approximate depth information, though with lower accuracy than dedicated 3D sensors.

Panoramic Camera Arrays: Multiple cameras (4-8 cameras arranged in a ring or positioned at different orientations) provide 360-degree coverage, ensuring labels in any direction are captured regardless of robot heading.

Stereo Cameras: Stereo camera pairs provide both images and depth information through disparity computation, potentially eliminating the need for separate 3D sensing hardware for some applications while providing both color imagery for OCR and geometric depth data.

3D Sensing Subsystem (230): Three-dimensional sensing provides spatial information about the environment:

LIDAR Sensors (235): 2D or 3D LIDAR sensors emit laser pulses and measure time-of-flight to determine distances to surfaces. 2D LIDARs scan in a plane (typically horizontal), while 3D LIDARs (multi-beam or scanning LIDARs) capture full 3D point clouds. LIDAR provides high-precision distance measurements (typically ±2-3 cm accuracy) at ranges up to 50+ meters, enabling accurate determination of shelf label positions.

Stereo Depth: Stereo cameras compute depth from disparity between left and right images. Depth accuracy degrades with distance (proportional to distance squared) but is effective for near-range applications (0.5-5 meters) common in warehouse aisle navigation.

Structured Light or Time-of-Flight Depth Sensors: Compact depth sensors (e.g., Intel RealSense, Microsoft Kinect) provide depth images. These sensors are effective indoors at ranges of 0.5-10 meters and can supplement or replace LIDAR in smaller facilities.

Monocular Depth Estimation: Machine learning models can predict depth from single camera images, eliminating the need for dedicated 3D sensing hardware. Neural networks trained on diverse datasets estimate depth from monocular images by learning perspective cues, object scales, and scene geometry. While depth accuracy is lower than LIDAR or stereo (±10-30 cm vs±2-5 cm), monocular depth estimation reduces hardware costs and may be suitable for applications where approximate localization suffices or when combined with other depth sources for improved accuracy.

Inertial Measurement Unit (IMU): Accelerometers and gyroscopes measure linear accelerations and angular velocities, providing high-frequency motion information (typically 100-200 Hz) for odometry integration and sensor fusion.

Computational Hardware: Onboard computing hardware executes perception, localization, and control algorithms. Typical platforms include industrial PCs with multi-core CPUs, GPUs for accelerating computational tasks, and sufficient memory. Real-time operating systems or frameworks may coordinate software modules and ensure deterministic performance.

### B. Software Architecture

The software architecture comprises several interconnected modules:

Sensor Drivers: Low-level drivers interface with hardware sensors, capturing images from cameras (210), three-dimensional spatial data from the 3D sensing subsystem, odometry from wheel encoders, and IMU measurements. Drivers ensure proper synchronization and timestamping of sensor data to enable accurate data association.

Image Processing and OCR Module (220): This module processes camera images to detect and recognize text, implementing text detection and character recognition techniques (described in detail in Section II).

3D Data Processing: Three-dimensional spatial data may undergo filtering (removing outliers, ground plane extraction), segmentation (identifying discrete objects or surfaces), and feature extraction. For camera-based depth systems, disparity maps may be computed using stereo matching algorithms.

Data Association Module (240): This module establishes geometric correspondence between camera images and three-dimensional spatial data through extrinsic calibration (camera-3D sensor calibration), performs 3D point projection onto camera images, and associates detected text regions with corresponding three-dimensional positions (Section III).

Landmark Map Management (255): Maintains a database of text-annotated landmarks, supports queries for landmark lookup by text content with spatial filtering, and implements updates for adding new landmarks or modifying existing ones based on new observations (Section IV).

Localization Module (260): Estimates the robot's pose (position and orientation) over time using sensor inputs including wheel odometry, IMU, landmark observations from text-annotated map, and optionally geometric features from the environment. Implements filtering or optimization techniques for sensor fusion (Section V).

Navigation and Planning (270): Higher-level modules plan paths to goal locations specified by semantic identifiers (e.g., “navigate to A5-3-2”), avoid obstacles detected by sensors, and execute navigation tasks. Integration with the localization module ensures the robot navigates accurately to goal locations with continuous pose feedback.

### Text Detection and Recognition (OCR Module 220)

### A. Text Detection

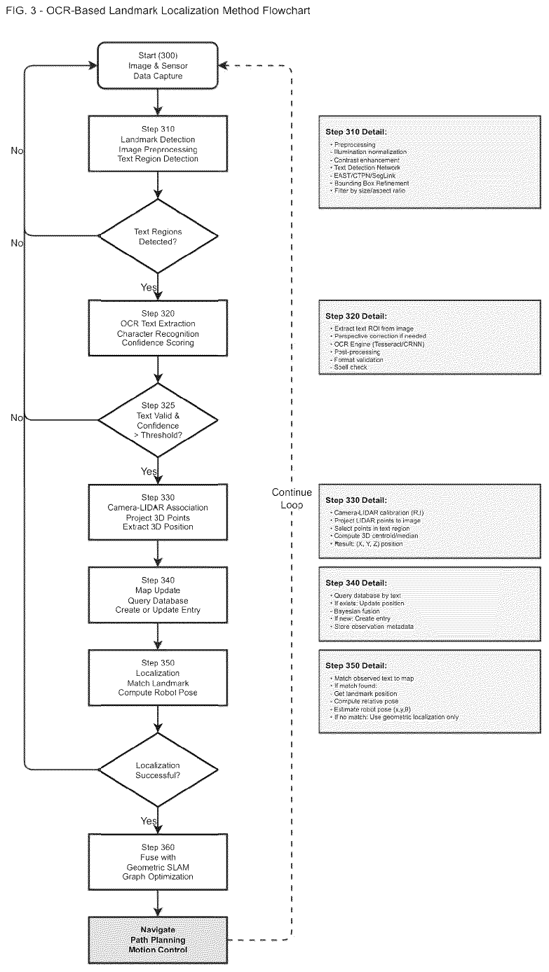

The first stage identifies regions in camera images that contain text, as implemented in landmark detection step (310) of FIG. 3.

Traditional Methods: Classical computer vision techniques detect text based on heuristic features:

Edge Detection: Text regions exhibit strong edge responses due to contrast between text and background. Canny edge detection or other edge filters identify candidate regions with high edge density.

Maximally Stable Extremal Regions (MSER): MSER algorithm detects blob-like structures with stable intensities across multiple thresholds, effective for text characters which form connected components.

Stroke Width Transform (SWT): SWT exploits the consistent stroke width property of text characters. Pixels belonging to text tend to have similar local stroke widths, distinguishing text from natural textures.

These methods are computationally efficient but may produce false positives (detecting textures or edges as text) and false negatives (missing text under challenging lighting conditions or degraded labels).

Machine Learning-based Detection: In some embodiments, text detection may employ machine learning techniques including neural networks. Various architectures may be utilized, such as region-based detection networks, single-shot detection approaches suitable for real-time applications, or specialized text detection models designed for natural scenes. These approaches may handle multi-oriented text, curved text, and varying aspect ratios common in warehouse environments where labels may be viewed from oblique angles.

Training data for machine learning-based text detection may include publicly available datasets, custom datasets collected in warehouse environments with annotated shelf labels, corridor signs, and safety signage, or combinations thereof.

Output: Text detection produces bounding boxes (rectangular regions) or oriented bounding boxes (rotated rectangles) or polygons (for irregular text) indicating locations of detected text in the image, along with confidence scores for each detection.

### B. Text Recognition (OCR Step 320)

After detecting text regions, the recognition stage extracts textual content.

Traditional OCR Approaches: In some embodiments, existing OCR frameworks may be utilized. Such frameworks may process images through stages including binarization (converting grayscale/color images to binary representation), text line and word segmentation (identifying individual text lines and words), character segmentation (isolating individual characters), character recognition (classifying characters using trained models), and linguistic analysis (applying language models to improve accuracy).

Traditional approaches may perform well on clean, horizontal text with standard fonts but may face challenges with low-resolution images, unusual fonts common in warehouse environments, rotated text, or degraded labels with wear or damage.

Machine Learning-Based OCR: In other embodiments, neural network approaches may be employed to achieve enhanced performance. Such approaches may include architectures combining feature extraction with sequence modeling, allowing the system to process entire text regions as sequences and output character sequences. Attention-based models may allow the system to focus on relevant parts of input images when generating output characters. In some implementations, detection and recognition may be combined in a single end-to-end trainable network, improving overall performance and reducing latency.

Commercial OCR services may provide pre-trained models with high accuracy across diverse fonts and languages but may require network connectivity and incur per-use costs, which may be impractical for real-time robot operation.

Custom Training: For optimal performance in warehouse environments, custom models can be trained on datasets of actual shelf labels, corridor signs, and other warehouse-specific text. Training data includes:—Images of labels captured from various distances (0.5-10 meters)—Different lighting conditions (bright warehouse lighting, dim areas, shadows, glare from overhead lights) Degraded labels (worn, dirty, partially damaged from forklift contact)—Various fonts used in the facility (sans-serif, bold, alphanumeric codes)—Different label types (printed labels, handwritten annotations, electronic shelf labels)

Output: Text recognition produces a string of recognized text (e.g., “A5-3-2”) along with confidence scores (0-1 range) indicating recognition certainty for the overall string and optionally per-character confidences.

### C. Post-Processing and Validation (Step 325)

As shown in FIG. 3, detected text undergoes validation (decision step 325) to determine if the text is valid and confidence exceeds a predetermined threshold. OCR outputs undergo validation and filtering before incorporation into the landmark map:

Format Validation: Shelf labels typically follow specific formats dictated by warehouse management systems (e.g., alphanumeric codes with expected patterns like “A5-3-2” for aisle-bay-level or “G” for corridor identifiers). Regular expressions or parsing rules verify that recognized text matches expected formats. Invalid results (e.g., random character sequences, extremely short or long strings) are rejected.

Confidence Thresholding: OCR engines provide confidence scores reflecting recognition certainty. Low-confidence detections (e.g., confidence <0.7) are discarded to prevent false positives that would corrupt the landmark map.

Temporal Filtering: When processing video streams, the same label is observed across multiple frames as the robot moves. Consensus algorithms (majority voting, temporal smoothing with exponential weighted average) combine observations from multiple frames to improve robustness. A label is only accepted if consistently detected across N consecutive frames (e.g., N=3 frames), reducing false positives from transient detection errors.

Geometric Consistency: Labels at a given physical position should report the same text across different viewpoints and robot positions. Geometric reasoning verifies consistency: if two observations with different text content are associated with the same 3D position (within tolerance), one is erroneous and can be rejected.

Spell Checking and Dictionary Validation: For environments with known label vocabulary, detected text can be validated against a dictionary of expected labels. Close matches can be corrected (e.g., “AS-3-2” corrected to “A5-3-2” if “A5” is known aisle).

### Association of Text with 3D Positions (Step 330, Module 240)

### A. Camera-3D Sensor Calibration (Module 240)

To associate detected text with 3D spatial positions, the geometric relationship between cameras (210) and the 3D sensing subsystem must be established through calibration.

Extrinsic Calibration: Determines the rigid transformation (rotation matrix R and translation vector t) from the 3D sensor coordinate frame to the camera coordinate frame. With this transformation, a 3D point P_S in 3D sensor coordinates is transformed to camera coordinates as:

$$P\_C = R \times P\_S + t$$

And then projected onto the image plane using camera intrinsic parameters (focal lengths f_x and f_y, principal point c_x and c_y):

$$u = f\_x \times ( X\_C / Z\_C ) + c\_xv = f\_y \times ( Y\_C / Z\_C ) + c\_y$$

where (u, v) are pixel coordinates, (X_C, Y_C, Z_C) are 3D coordinates in camera frame, and f_x, f_y, c_x, c_y are intrinsic parameters determined from camera calibration.

Intrinsic Calibration: Camera intrinsic parameters and distortion coefficients are determined through standard camera calibration procedures using checkerboard patterns or other calibration targets observed from multiple viewpoints.

Calibration Procedures: Several methods may perform camera-3D sensor calibration:

Target-Based Method: A calibration target (checkerboard pattern or fiducial marker array) is observed simultaneously by camera and 3D sensing subsystem. Correspondences between target features detected in the image and 3D points on the target measured by the 3D sensor (from planar surface fitting or feature extraction) establish the transformation. Multiple viewpoints improve calibration accuracy.

Motion-Based Calibration: Calibration may observe the environment from multiple viewpoints as the robot moves. Optimization algorithms find the transformation that best aligns camera and 3D sensor observations across all viewpoints by maximizing consistency of projected correspondences.

Label-Based Calibration: Detected shelf labels themselves can serve as calibration targets. If label positions are detected in both camera images (via OCR with bounding boxes) and 3D sensor data (as planar surfaces or distinctive features), correspondences provide calibration constraints. This enables online calibration refinement during normal operation.

Result: Calibration yields the transformation matrix [R|t] enabling projection of 3D points onto camera images or back-projection of camera pixels to 3D rays in the 3D sensor coordinate frame.

B. Associating OCR Detections with 3D Points (Module 240, Step 330)

With calibration established, the 3D position of detected text is determined:

Method 1—3D Point Projection: 1. The 3D sensing subsystem measures spatial data of the environment 2. 3D points are projected onto the camera image using calibration transformation [R|t] and intrinsic parameters K 3. For each detected text bounding box from OCR module (220), find 3D points that project inside the box (within pixel boundaries) 4. These points lie on the surface containing the text (shelf face, sign surface) 5. Compute statistics (mean, median, or robust estimation) of these points to estimate the text position 6. The text label is associated with this 3D position (x, y, z) in the global reference frame

Method 2—Plane Fitting: 1. Shelf labels typically lie on planar surfaces (shelf faces, vertical signs mounted on walls or poles) 2. Fit a plane to 3D points projecting into the text region using robust fitting techniques: ax+by+cz+d=03. Compute the ray from camera center through the text bounding box center in image coordinates 4.Compute the intersection of the camera ray with the fitted plane 5. This intersection point is the 3D position of the text 6. Plane fitting may be more robust when label surface is partially occluded or when point density is variable 7. The plane normal vector (a, b, c) from the fitted plane may optionally be stored with the landmark, providing surface orientation information that can constrain robot heading during localization (reducing orientation ambiguity when observing a single landmark)

Method 3—Stereo Depth: If stereo cameras are used (part of imaging subsystem 200), depth may be directly computed from disparity. The 3D position of the text is:

$$Z = baseline \times f\_x / disparity X = ( u - c\_x ) \times Z / f\_x Y = ( v - c\_y ) \times Z / f\_y$$

where (u, v) is the text center in pixels, Z is depth from disparity computation, baseline is the stereo baseline (distance between left and right cameras), and disparity is computed through stereo matching algorithms.

Method 4—Depth Sensor Direct: If depth sensors (structured light or time-of-flight) are used, depth value Z is directly read from the depth image at the text bounding box location, and 3D position is computed similar to stereo method.

Method 5—Monocular Depth Estimation: If a monocular camera is used with machine learning-based depth estimation, a neural network processes the camera image to predict a depth map. The depth value at the text bounding box location is extracted from the predicted depth map and used to compute 3D position:

$$Z = depth\_predicted ( u , v ) \times scale\_factor X = ( u - c\_x ) \times Z / f\_x Y = ( v - c\_y ) \times Z / f\_y$$

where depth_predicted(u, v) is the neural network's depth prediction at pixel (u, v), and scale_factor resolves scale ambiguity (obtained from known landmark heights, odometry integration, or calibration against ground truth depth measurements). Due to lower depth accuracy compared to dedicated 3D sensors, position uncertainty is higher (typically ±10-30 cm vs ±2-5 cm for LIDAR), which is reflected in larger covariance values for landmarks observed via monocular depth estimation.

Uncertainty Estimation: The estimated 3D position has associated uncertainty due to sensor noise, calibration errors, and discretization of pixel coordinates. Uncertainty may be modeled as a covariance matrix representing position uncertainty in x, y, z directions. Covariance may be estimated from:—3D sensor measurement accuracy—Pixel position uncertainty in bounding box Calibration parameter uncertainties—Propagated through projection equations using error propagation techniques

### Text-Annotated Landmark Map (Database 255, Step 340)

### A. Landmark Representation

Each landmark in the map (255) is represented as an entry containing:

Text Content (string): The string extracted by OCR (e.g., “A5-3-2”). This serves as a unique or semi-unique identifier for the landmark. In warehouses, location labels are typically unique, though product labels may repeat.

3D Position (vector): The landmark's position in the global coordinate frame (x, y, z) in meters. The global frame is established during initial mapping (e.g., warehouse entrance as origin) or tied to a facility coordinate system if available.

Covariance (matrix): A 3×3 symmetric positive-definite covariance matrix Σ representing uncertainty in the position estimate in meters squared. Diagonal elements represent variance in x, y, z directions, while off-diagonal elements represent correlations.

Surface Normal (optional Vector): for Landmarks on Planar surfaces, the surface normal vector (n_x, n_y, n_z) represents the orientation of the plane containing the landmark. This may be obtained from plane fitting during 3D data association. The surface normal enables improved single-landmark localization by constraining robot orientation, reducing pose ambiguity from a circular region to discrete hypotheses or a point estimate. Surface normals are particularly useful for shelf labels (approximately horizontal normal vectors pointing outward from shelf faces) and vertical aisle signs (normal vectors in the horizontal plane).

Observations (list): Metadata including:—Number of times the landmark has been observed (observation count)—Timestamps of first and most recent observations (for temporal tracking)—Observation view angles and distances (for visibility analysis)—Confidence scores from OCR for each observation (to weight observations)—Robot poses from which landmark was observed (for graph SLAM)

Appearance Descriptor (vector): Visual features of the landmark extracted from image region containing the text. Features may include:—SIFT or ORB keypoint descriptors from label region—Deep learning-based image embeddings (e.g., from ResNet or VGG features)—Color histogram of label (for distinguishing labels with same text)—Geometric properties (size, aspect ratio, orientation) These descriptors enable visual verification when the same landmark is observed again, particularly useful for disambiguating labels with identical text at different locations.

Landmark Type (enum): Classification of landmark type:—Shelf label (product storage location)—Aisle sign (large overhead corridor identifier)—Corridor label (smaller directional sign)—Safety sign (exit, equipment, hazard)—Other Type information aids in localization weighting (corridor signs visible from farther distances provide different information than small shelf labels).

### B. Map Construction (Step 340)

During an initial mapping phase or continual operation, the robot builds the landmark map:

Landmark Detection: As the robot navigates, the OCR module (220) continually detects text in camera images (step 310, 320). Each detection is processed through validation (step 325) and associated with a 3D position (step 330). Valid detections proceed to map update (step 340).

Landmark Initialization: When a text label is detected and no corresponding landmark exists in the map (determined by checking if the recognized text matches any existing landmark's text content and if geometric position is within expected proximity), a new landmark is created and added to the map (255) with:—Text content from OCR 3D position from data association—Initial covariance based on sensor uncertainties—Surface normal (if obtained via plane fitting during data association)—Observation metadata (timestamp, confidence, robot pose)—Appearance descriptor extracted from image

Landmark Matching: When detected text matches an existing landmark's text content, the system determines whether this is a re-observation of the known landmark or a new landmark with the same text (duplicate label scenario):

Distance Check: If the detected position is within a threshold distance (e.g., 0.5 meters for shelf labels, 2.0 meters for large signs) of the existing landmark position, accounting for position uncertainties from both prior estimate and new observation, it is a re-observation. Mahalanobis distance accounts for covariance: d_M²=(x_new−x_prior)\hat{ }TΣ\hat{ }(−1)(x_new−x_prior).

Appearance Matching: Visual appearance descriptors are compared using similarity metrics (cosine similarity for deep features, L2 distance for histograms). High similarity (e.g., cosine>0.8) confirms re-observation.

Temporal Consistency: If landmark was recently observed (within last 10-60 seconds) and robot motion is consistent with re-observing same landmark, increases confidence in match.

Disambiguation: If text is ambiguous (e.g., multiple shelves labeled “Level 2” in different aisles), additional context disambiguates:
A. Nearby landmarks (if robot is near known “Aisle A” labels, “Level 2” is in Aisle A)
B. Robot pose estimate (expected landmark location based on current position)
C. Appearance descriptors (visual differences in label design, wear patterns)

Landmark Update: When a known landmark is re-observed, its position estimate is refined through Bayesian fusion (Kalman update):

Kalman Update: Innovation: y=z−H×x_prior (where z is new 3D measurement, x_prior is prior position estimate, H is observation model typically identity matrix for direct position measurement) Innovation covariance: S=H×Σ_prior×H\hat{ }T+R (where R is measurement noise covariance) Kalman gain: K=Σ_prior×H\hat{ }T×S\hat{ }(−1) Updated position: x_updated=x_prior+K×y Updated covariance: Σ_updated=(I−K×H)×Σ_prior

Multiple observations reduce uncertainty (covariance shrinks), improving position accuracy. After many observations (e.g., 10+), position accuracy can reach centimeter-level even with sensors having decimeter-level individual measurement uncertainty.

Observation metadata is updated:—Increment observation count —Update most recent observation timestamp—Add new appearance descriptor to set (or update running average)—Record robot pose for graph SLAM constraints

### C. Dynamic Map Updates

As warehouse layouts change (shelves rearranged, labels replaced, products moved), the map must adapt:

Change Detection: When a landmark is expected at a certain position (based on the map) but is not detected during multiple passes (e.g., robot navigates through area 5 times without observing previously known landmark), a change is flagged. Conversely, when new text is detected at a position where a different landmark was previously mapped, a change is detected.

Label Replacement: If label “A5-3-2” is detected at a new position far from its mapped position (beyond reasonable uncertainty, e.g., >1 meter for shelf labels which are typically stationary), the system determines the cause:

Label Relocated: If high confidence in new observation (high OCR confidence, multiple frames, consistent measurements), update the existing landmark to the new position. This handles scenarios where shelving is rearranged.

Duplicate Label: If uncertain whether label moved or is a duplicate, create a new landmark instance at the new position while retaining the old landmark (marked as inactive or lower confidence). Over time, continued observations will confirm which is correct.

Sensor Error: If new observation has low confidence, conflicts with multiple other reliable observations, or is geometrically impossible (e.g., label detected inside solid obstacle), flag as sensor error and discard.

Label Removal: Landmarks not observed for an extended period (e.g., months of operation, configurable threshold based on facility change rate) may be marked as inactive. Inactive landmarks are retained in the map database but not used for localization, allowing recovery if label reappears. After even longer periods (e.g., years), inactive landmarks may be archived or removed to reduce database size.

Version Control: Maps may be versioned with timestamps, allowing:-Rollback to previous map version if incorrect updates were made-Historical queries (“where was label A5-3-2 on date X?”)—Change tracking for warehouse management integration (“which labels moved this month?”)—Multi-hypothesis tracking (maintaining multiple possible map states when changes are uncertain)

Collaborative Fleet Updates: In multi-robot deployments, multiple robots contribute observations. When robot A detects a label change, the updated map is shared with robots B, C, D via wireless communication or central map server. Conflict resolution algorithms handle discrepancies:—Statistical fusion: Weight observations by confidence and observation count—Outlier detection: Reject observations inconsistent with majority—Human review: Flag conflicts exceeding threshold for human operator verification

### Localization Using Text-Annotated Landmarks (Module 260, Steps 350, 360)

A. Global Localization (step 350)

Global localization estimates the robot's absolute pose from landmark observations without prior knowledge of pose (solving the “kidnapped robot problem”).

Single Landmark Observation: When the robot observes a landmark by detecting text “A5-3-2” (step 320):

Query the landmark map database (255) for the landmark position L_global=(x_L, y_L, z_L) in global coordinates

Measure the landmark position relative to the robot L_robot=(x_r, y_r, z_r) from 3D sensing subsystem (230) and camera (210) through data association (step 330)

Estimate the robot's global position by geometric transformation:

For 2D localization (x, y, θ where θ is heading angle): The robot's position R=(x, y) and the landmark's position in global frame L_global are related to the observed relative position L_robot by:

$$L\_global = R + Rot ( θ ) \times L\_robot$$

where Rot(θ) is the 2D rotation matrix. This provides constraints on robot pose.

With orientation θ unknown, observing a single landmark constrains position to a circle of possible positions (rotation around landmark). However, if the 3D sensing subsystem can estimate the orientation of the observed landmark surface, the circular ambiguity may be substantially reduced or eliminated. For landmarks on planar surfaces (shelf labels on vertical shelf faces, aisle signs on vertical poles or overhead mounts), plane fitting to the 3D spatial data provides an estimate of the surface normal vector. The surface normal, combined with the known mounting orientation of labels (typically facing outward from shelves or perpendicular to aisles), constrains the robot's orientation. For example, if a shelf label is detected at position L_robot and the fitted plane normal indicates the shelf face is oriented at angle α in the global frame, the robot's heading θ is constrained to θ≈α±180° (facing toward or away from the shelf). This reduces the pose ambiguity from a circular region to typically two discrete pose hypotheses, or in cases where the robot's approximate heading is known from prior motion (e.g., from gyroscope integration), to a single pose estimate with position accuracy approaching the 3D sensor's ranging accuracy (typically 2-5 cm). Multiple landmarks or landmarks observed from multiple viewpoints as the robot moves uniquely determine pose.

Multiple Landmark Observations: Observing Multiple landmarks simultaneously (e.g., detecting aisle sign “G” and shelf label “G-12-3” in same image) provides overconstrained pose estimation. The robot's pose is estimated by optimization minimizing reprojection error:

$$minimize\_ \{ x , y , θ \} Σ\_i {‖ {L\_i}^{⋀} \{ global \} - ( R ( θ ) \times {L\_i}^{⋀} \{ robot \} + T ) ‖}^{2} \_ \{ {Σ\_i}^{⋀} \{ - 1 \} \}$$

where:—L_i\hat{ }{global} are landmark positions from map database (255)—L_i\hat{ }{robot} are observed relative positions from sensors—R(θ) is rotation matrix for heading θ−T=(x, y) is robot position—Σ_i is covariance of landmark i (weighting observations by uncertainty)—Sum is over all observed landmarks i

This is a weighted least-squares problem solved via iterative methods (Gauss-Newton, Levenberg-Marquardt). For 2D (x, y, θ), this is a 3-parameter optimization typically converging in <10 iterations.

For 3D (x, y, z, roll, pitch, yaw), full 6-DOF pose estimation uses similar formulation with 3D rotation matrices and 3D positions.

Initialization After Reboot: When the robot starts up in an unknown position (cold start scenario), the localization process begins with the method flowchart shown in FIG. 3:

At start step (300), the robot captures images from camera (210) and sensor data from 3D sensing subsystem (230), then proceeds to landmark detection (steps 310, 320)

Even a single distinctive landmark (e.g., corridor sign “G” which may be unique in the facility) enables approximate pose initialization (position constrained to region near landmark; if landmark surface orientation can be estimated from 3D data, orientation ambiguity may be reduced to discrete hypotheses or resolved entirely)

As the robot observes additional landmarks while moving (odometry provides relative motion estimates), pose estimates converge to high accuracy through recursive Bayesian estimation

After observing 2-3 distinct landmarks, position and orientation are typically determined to <10 cm, <5 degree accuracy

Initialization time is typically 10-30 seconds of navigation

This automatic initialization eliminates the need for human operators to manually position the robot at a known location or enter initial pose estimates, reducing deployment and restart time.

### B. Continuous Localization and Drift Correction (Steps 350, 360)

During operation, the robot maintains a continuous pose estimate using sensor fusion:

Odometry Integration: Wheel encoders and IMU integrate robot motion. Odometry provides high-frequency (50-200 Hz) pose updates with low latency but suffers from drift—errors accumulate over time due to wheel slip, calibration errors, sensor noise, and floor irregularities. Drift rates are typically 1-5% of distance traveled (e.g., 10 cm error after 10 meters).

Continuous Geometric Localization: In some embodiments, geometric localization methods may track features in the environment to estimate robot pose. Such methods may utilize features extracted from sensor data and typically have lower drift than raw odometry but may still accumulate errors over long distances and may be subject to localization failures in textureless or repetitive environments.

Landmark Corrections (Step 360): Each time a known landmark is re-observed (text detected and matched to database), it provides an absolute position measurement. The localization system (260) may fuse this measurement with other pose estimates through filtering or optimization techniques:

Extended Kalman Filter (EKF) Approach: An Extended Kalman Filter maintains a state estimate including robot pose and velocities. State vector:

$${x = \{ x\_position , y\_position , θ\_orientation , v\_x , v\_y , ω\_angular \_velocity ]}^{⋀} T$$

Prediction Step (using odometry/IMU):

$$x\_ \{ k \vert k - 1 \} = f \{ x\_ \{ k - 1 \vert k - 1 \} , u\_k ) \# motion model with control input u$$

$$P\_ \{ k \vert k - 1 \} = F \times P\_ \{ k - 1 \vert k - 1 \} \times F \hat{} T + Q \# covariance prediction$$

where F is the Jacobian of motion model f, P is state covariance, and Q is process noise covariance.

Update Step (when landmark observed):

$$y = z - h ( x\_ \{ k \vert k - 1 \} ) \# innovation ( measurement residual )$$

$$S = H \times P\_ \{ k \vert k - 1 \} \times H \hat{} T + R \# innovation covariance$$

$$K = P\_ \{ k \vert k - 1 \} \times H \hat{} T \times S \hat{} \{ - 1 \} \# Kalman gain$$

$$x\_ \{ k \vert k \} = x\_ \{ k \vert k - 1 \} + K \times y \# state update$$

$$P\_ \{ k \vert k \} = ( I - K \times H ) \times P\_ \{ k \vert k - 1 \} \# covariance update$$

where:—z is the landmark observation (landmark ID and relative position)—h is the observation model (predicting landmark relative position from robot pose and landmark global position from map)—H is the Jacobian of observation model-R is measurement noise covariance (from landmark position uncertainty and sensor noise)

Landmark observations provide absolute corrections, preventing unbounded drift. Each landmark observation “resets” accumulated odometry error in the vicinity of the landmark.

Graph-based Optimization Approach (step 360): in Some embodiments, a graph-based approach may be utilized where nodes represent robot poses at different times, and edges represent constraints:

Odometry edges: Connect consecutive robot poses, represent relative motion from odometry with associated uncertainty

Geometric feature edges: Connect robot poses to geometric features detected by sensors with relative position constraints

Landmark edges: Connect robot poses to text-annotated landmark nodes with known global positions from database (255)

Landmark observations create edges from robot pose nodes to landmark nodes with fixed global positions. Optimization over the graph may find the configuration of poses and feature positions that best satisfies all constraints:

$$minimize Σ\_edges {‖ z\_edge - h\_edge ( x\_nodes ) ‖}^{2} \_ \{ {Σ\_edge}^{⋀} \{ - 1 \} \}$$

where the sum is over all edges (odometry, geometric features, text landmarks), z_edge are measurements, h_edge are prediction functions, x_nodes are node states, and Σ_edge are edge covariances.

Graph optimization distributes errors globally, reducing accumulated drift. Text-annotated landmarks act as “anchors” with known absolute positions, preventing global drift while allowing local geometric consistency. Optimization is typically performed:—Continuously at low frequency (every 1-10 seconds) for incremental updates—On-demand when large loop closures or landmark observations occur—Offline after data collection for post-processing and map refinement

The combination of high-frequency geometric tracking (geometric SLAM, 10-20 Hz) with intermittent absolute landmark corrections (text landmarks, observed every few seconds when labels are in view) provides both smooth continuous pose estimates and long-term drift-free localization.

### Integration with Navigation and Task Execution (Module 270)

### A. Semantic Task Specification

Text-annotated landmarks enable natural task specifications using semantic identifiers that match human-understandable warehouse labeling:

Location-Based Tasks: Operators or warehouse management systems (WMS) specify tasks using label identifiers that directly match shelf labels:—“Navigate to location A5-3-2 and pick up pallet P12345”—“Deliver goods to corridor G, bay 7, level 1”

The robot (10) queries its landmark map database (255) to find the 3D position corresponding to text “A5-3-2” and plans a path to that location. This direct mapping eliminates the need for separate coordinate systems or manual mapping between WMS identifiers and robot navigation coordinates.

Search and Inventory Tasks:—“Find all items in Aisle G” Robot identifies all landmarks with text containing “G” and plans a route visiting those locations—“Scan all shelves in Zone A” Robot determines region bounds from landmarks with “Zone A” prefix and plans coverage path

Multi-Waypoint Tasks: Complex tasks with multiple sequential locations:—“Visit B3-2-1, then D7-4-3, then return to charging station”—Robot looks up each landmark position and generates multi-waypoint path plan

### B. Path Planning Integration

The landmark map (255) integrates with path planning module (270):

Waypoint Generation: Landmarks serve as natural waypoints. A path from current position to goal location “A5-3-2” may include intermediate waypoints at other landmarks (e.g., corridor sign “A5”) that provide localization updates along the route.

Localization-Aware Planning: Path planner considers localization uncertainty (from localization module 260 covariance estimates) and plans paths that pass near landmarks to enable frequent localization updates. For example:—When uncertainty is high (e.g., after obstacle avoidance maneuver in featureless area), planner routes toward areas with known landmarks—When uncertainty is low (shortly after landmark observation), planner may take more direct routes even through areas with fewer landmarks—Landmark density can be treated as a “localization cost map” influencing path planning

Robust Execution: If localization fails (pose uncertainty exceeds threshold), robot enters recovery mode:—Slow down or stop Actively search for visible landmarks by rotating in place—Move toward areas containing landmarks (e.g., toward shelves)—Upon landmark detection, re-initialize localization and resume task

### Multi-Robot Fleet Coordination

In deployments with multiple autonomous mobile robots, the system extends to collaborative operation:

Shared Landmark Map: Multiple robots contribute observations to a shared landmark map database (255) hosted on:—Centralized server (cloud or on-premise data center)—Distributed database with eventual consistency (robots sync periodically)—Edge computing infrastructure distributed throughout facility

Collaborative Mapping: As robots navigate, each robot contributes newly discovered landmarks to the shared map:—Robot A discovers label “B8-5-2” not previously in map→creates landmark and uploads to shared database—Robots B, C, D download updated map and can use “B8-5-2” for localization—aster map coverage of large facilities (N robots provide~N×speedup)

Consistency Enforcement: When different robots observe the same landmark, measurements may differ due to sensor noise or calibration differences:

Statistical Fusion: Combine observations from multiple robots using weighted averaging where weights are based on observation confidence and robot sensor quality. If robot A observes landmark at position (10.2, 5.3, 1.5) with covariance Σ_A and robot B observes at (10.4, 5.2, 1.5) with covariance Σ_B, fused position is weighted average with combined covariance:

$$x\_fused = ( {Σ\_A}^{\hat{}} \{ - 1 \} + {Σ\_B}^{\{ - 1 \} )} \{ - 1 \} \times ( {Σ\_A}^{\hat{}} \{ - 1 \} x\_A + {Σ\_B}^{\hat{}} \{ - 1 \} x\_B ) Σ\_fused = ( {Σ\_A}^{\hat{}} \{ - 1 \} + {Σ\_B}^{\{ - 1 \} )} \{ - 1 \}$$

Outlier Detection: If robot C reports landmark “A5-3-2” at position (15.0, 8.0, 1.5) inconsistent with other observations, use RANSAC or statistical outlier detection to identify and reject C's observation (may indicate sensor fault or misdetection)

Conflict Resolution for Label Changes: If robot A consistently observes text “B3” at position (5, 10, 1.5) and robot B observes text “B4” at the same position:
A. Flag conflict for review
B. Investigate whether label was changed (B3→B4)
C. Determine which observation is correct based on timestamps (more recent observation preferred), observation counts, or human review
D. Update map accordingly

Map Distribution: Efficient map distribution to fleet: Incremental updates: Only changes since last sync transmitted (reduces bandwidth)-Prioritized updates: Critical changes (label relocations, new areas) distributed immediately, minor refinements batched-Compression: Landmark maps are relatively compact (thousands of landmarks=megabytes), but efficient encoding further reduces transmission—Version control: Each map update has version number, robots track which version they have

### Alternative Embodiments and Implementation Variations

### A. Camera Configurations

Monocular vs. Stereo vs. Multi-Camera:—Monocular (200 with single camera 210): Simplest, lowest cost ($100-500 per camera). May be paired with separate depth sensor or use machine learning-based monocular depth estimation. Advantage: Minimal hardware, flexible depth sensing options (dedicated 3D sensor for high accuracy or monocular depth estimation for lower cost). Disadvantage: When using monocular depth estimation, depth accuracy is lower than stereo or dedicated 3D sensors; scale ambiguity requires resolution through additional constraints or sensors.

Stereo (200 with stereo pair): Provides depth directly from cameras through disparity computation. No separate LIDAR needed for depth (though LIDAR may still be used for geometric mapping). Advantage: Combined color and depth from one sensor type. Disadvantage: Depth accuracy degrades with distance, computational cost of stereo matching.

Multi-Camera Array (200 with 4-8 cameras 210): 360-degree coverage ensures labels in any direction are observed regardless of robot heading. Advantage: No blind spots, can detect landmarks behind robot. Disadvantage: Higher cost, increased computational requirements for processing multiple streams, complex multi-camera calibration.

High-Resolution Zoom Cameras: For large warehouses with labels visible at long distances (10-20 meters), high-resolution cameras (12+megapixels) with optical zoom or telephoto lenses extend the effective range of landmark detection. Narrow field-of-view telephoto camera can complement wide-field cameras: wide camera for nearby landmarks, telephoto for distant corridor signs.

### B. OCR Techniques

Cloud-Based vs. On-Device OCR:-Cloud APIs (Google Cloud Vision, AWS Textract, Microsoft Azure Computer Vision): High accuracy (often 95-99% on clean text), handles many languages and fonts, continuously improved models. Requires network connectivity (WiFi coverage throughout facility), latency ~100-500 ms for round-trip API call, costs per API call. Suitable when: network is reliable, latency acceptable, volume justifies cost.

On-Device OCR (Tesseract, custom CNNs running on robot GPU): Runs locally on robot computational hardware, no latency from network round-trip (typically 10-50 ms inference time), no per-use costs after initial development, no dependency on network connectivity. May have lower accuracy than cloud services (especially for degraded text), requires GPU for real-time deep learning models. Suitable when: network unavailable or unreliable, low latency required, high volumes make cloud costs prohibitive, data privacy concerns.

Hybrid Approach: Use on-device OCR for primary operation with cloud OCR as backup for low-confidence detections or challenging cases. Best of both worlds but adds complexity.

Custom OCR Models: Training custom models on warehouse-specific labels may improve accuracy for specialized fonts, formats (alphanumeric codes, barcode numbers), or degraded labels common in the specific facility:-Collect dataset of labeled images from target warehouse-Fine-tune pre-trained OCR models on custom dataset May achieve improved accuracy over generic models-Particularly valuable for unusual fonts, handwritten annotations, or facility-specific label formats

### C. 3D Sensing Modalities

LIDAR (235): High accuracy (±2-3 cm ranging accuracy), long range (up to 100 m for high-end models, 20-50 m typical for robot applications), unaffected by lighting conditions (active sensing), provides direct 3D measurements. Higher cost ($1000-10000+depending on specifications), some models affected by bright sunlight or retroreflective materials, point clouds can be sparse. Best for: large facilities, outdoor/indoor transitions, high accuracy requirements.

Stereo Depth: Moderate accuracy at short-medium range (±1-5 cm at 1-3 meters, degrading with distance), cost-effective (stereo cameras $200-2000), provides dense depth maps aligned with color images. Performance degrades in low texture scenes (blank walls), affected by lighting (requires adequate illumination), computational cost for dense stereo matching. Best for: cost-sensitive applications, shorter ranges (<5 m), when dense depth maps needed.

RGB-D Sensors (RealSense, Kinect): Easy integration (single sensor provides color and depth), provides aligned color and depth images, moderate cost ($200-500). Limited range (typically <10 m, effective range 0.5-5 m), performance degrades with bright sunlight (structured light sensors) or certain materials, some models have high computational requirements. Best for: small-medium facilities, indoor-only operation, rapid prototyping.

Monocular Depth Estimation: Machine learning models trained on large datasets may estimate depth from single camera images without requiring stereo pairs or active depth sensing. Neural network architectures process monocular images to predict per-pixel depth maps, learning depth cues from perspective geometry, object sizes, occlusions, and semantic understanding of scenes.

Advantages: Requires only camera hardware (minimal cost, no additional 3D sensors needed), works with existing monocular camera installations, provides dense depth estimates for entire image, can leverage the same camera used for OCR without additional sensors.

Limitations: Depth accuracy is typically lower than LIDAR (±10-30 cm vs±2-5 cm for LIDAR), especially at longer ranges. Scale ambiguity is inherent (predicts relative depth; absolute metric scale requires calibration or auxiliary constraints). Accuracy depends heavily on training data quality and similarity between training environments and deployment environment. Performance may degrade in unusual viewpoints, novel object types not seen during training, or environments substantially different from training data. Requires computational resources for real-time neural network inference (GPU recommended).

Reliability Comparison: For landmark localization in warehouse environments, dedicated 3D sensors (LIDAR, stereo, structured light) provide more reliable and accurate depth measurements. Monocular depth estimation is best suited for: cost-constrained deployments where approximate localization suffices, backup/redundancy when primary depth sensors fail or have limited coverage, applications where labels are at known heights (reducing scale ambiguity), or hybrid systems combining monocular depth with occasional absolute depth measurements for scale correction.

Scale Resolution: The scale ambiguity in monocular depth estimation can be resolved through: observing landmarks at known heights (shelf labels at standard 1.5 m height), integrating with wheel odometry (using motion parallax to infer scale), occasional observations from other depth sensors (LIDAR, stereo), or learned priors about warehouse geometry and typical object sizes.

### D. Map Storage and Distribution

On-Robot Storage: Landmark maps stored locally on robot computational hardware (SSD storage). Suitable for: single-robot deployments, facilities with no IT infrastructure, environments where network unreliable. Each robot maintains independent map (no sharing), requires manual map transfer if deploying additional robots.

Cloud-Based Maps: Maps stored on cloud servers (AWS, Azure, Google Cloud), accessible by multiple robots via wireless network (WiFi, 5G). Enables: map sharing across fleet, centralized map management and monitoring, offsite backup and disaster recovery, integration with WMS and other enterprise systems. Requires: reliable network connectivity throughout facility, ongoing cloud service costs, data security considerations for facility layout information.

Edge Computing: Hybrid approach with map data distributed across edge servers in the facility (e.g., one edge server per warehouse zone). Reduces latency compared to cloud (local network access), provides redundancy (multiple edge servers), scales well with facility size. Moderate infrastructure requirements (install and maintain edge servers), more complex than pure cloud or on-robot approaches.

### E. Computational Optimization

Model Quantization: Machine learning models may be quantized to reduced precision, reducing model size and improving inference speed with minimal accuracy loss. Enables real-time performance on less powerful hardware or processing more camera streams.

Multi-Scale Processing: Process images at multiple resolutions: low resolution for fast detection of large signs, high resolution for small shelf labels. Adaptive resolution based on expected label size and distance improves efficiency.

Region of Interest Processing: Use geometric priors to limit OCR processing to regions expected to contain labels:-Shelf labels typically at height 0.5-2.5 meters above ground-Corridor signs typically overhead at height 2.5-5 meters-Process only image regions corresponding to these height ranges based on camera pose and calibration-Can reduce computational load by 50-75%

### System Capabilities

The disclosed system is configured to provide accurate localization for autonomous robots in environments like warehouses and retail facilities using existing infrastructure without requiring installation of artificial markers. The system is operable to detect and recognize text on shelf labels and corridor signs at ranges suitable for warehouse navigation, maintain compact landmark maps requiring minimal storage, process sensor data with low latency suitable for real-time robot operation, and adapt to dynamic environments where labels may be moved or replaced. The system enables automatic localization initialization without manual pose entry and supports multi-robot fleets that collaboratively build and maintain shared landmark maps.

### Other Implementation Options

It should be understood that the example embodiments described above may be implemented in many different ways. In some instances, the various “data processors” may each be implemented by a physical or virtual general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system. One or more central processor units are attached to the system bus and provide for the execution of computer instructions. Also attached to system bus are typically I/O device interfaces for connecting disks, memories, and various input and output devices. Network interface(s) allow connections to various other devices. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

The above description included an explanation of several example embodiments. It should be understood that while a particular feature may have been disclosed with respect to only one of several embodiments, that particular feature may be combined with one or more other features of the other embodiments as may be desired and advantageous for any given or particular application. It is, of course, not possible to describe every conceivable combination of components or methodologies for purposes of describing the innovations herein, and one skill in the art may now, in light of the above description, recognize that many further combinations and permutations are possible. Also, to the extent that the terms “includes,” and “including” and variants thereof are used in either the detailed description or the claims, these terms are intended to be inclusive in a manner similar to the term “comprising”.

It also should be understood that the block and flow diagrams may include more or fewer elements, be arranged differently, or be represented differently. The computing devices, processors, controllers, firmware, software, routines, or instructions as described herein may also perform only certain selected actions and/or functions. Therefore, it will be appreciated that any such descriptions that designate one or more such components as providing only certain functions are merely for convenience.

When a series of steps has been described above with respect to the flow diagrams, the order of the steps may be modified in other implementations. In addition, the operations and steps may be performed by additional or other modules or entities, which may be combined or separated to form other modules or entities. For example, while a series of steps has been described with regard to certain figures, the order of the steps may be modified in other implementations consistent with the principles explained herein. Further, non-dependent steps may be performed in parallel. Further, disclosed implementations may not be limited to any specific combination of hardware.

No element, act, or instruction used herein should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

Accordingly, the subject matter covered by this patent is intended to embrace all such alterations, modifications, equivalents, and variations that fall within the spirit and scope of the claims that follow.

1. A localization system for autonomous mobile robots, the system comprising:
an imaging subsystem mounted on an autonomous mobile robot, said imaging subsystem configured to capture images of an environment during robot navigation, wherein said environment comprises shelving structures, storage racks, or corridor signage bearing textual labels indicating locations, zones, or directions;
a text extraction module configured to detect and extract textual content from said images without requiring installation of artificial markers or beacons;
a spatial positioning module configured to determine three-dimensional positions corresponding to detected textual content using at least one technique selected from: active depth sensing, passive depth sensing, or learned depth estimation;
a semantic landmark database configured to store associations between extracted textual content and corresponding three-dimensional positions in a global reference frame; and
a pose estimation module configured to:
compare currently observed textual content with entries in said semantic landmark database,
identify matches between observed text and stored landmarks,
compute robot pose from spatial relationships between matched landmarks and robot sensors, and
provide pose estimates enabling navigation without continuous pose tracking from initialization,
wherein said textual labels comprise pre-existing environmental features not installed specifically for robot localization, thereby eliminating infrastructure modification costs.

2. The system of claim 1, wherein said pose estimation module is configured to perform global localization initialization by:
upon system startup or reboot without prior knowledge of robot position:
capturing images and spatial data while said autonomous mobile robot is stationary or moving,
detecting textual content on environmental features using said text extraction module,
comparing detected textual content against entries in said semantic landmark database,
identifying at least one matching landmark having known three-dimensional position in said global reference frame;
computing an initial pose estimate from said at least one matching landmark by:
determining a spatial relationship between said robot and said matching landmark from sensor measurements,
constraining robot position based on known landmark position and measured spatial relationship,
when multiple landmarks are detected, resolving position and orientation from geometric constraints provided by multiple landmarks,
when single landmark is detected, constraining position to region around landmark or using surface orientation to further constrain orientation;
initializing continuous localization with said initial pose estimate; and
achieving localization without requiring:
manual entry of starting position by human operator,
continuous tracking from known initialization point,
auxiliary positioning systems such as GPS or installed beacons, or
prior knowledge of robot location,
wherein global localization initialization enables autonomous startup and operation without human intervention for pose initialization.

3. The system of claim 1, wherein said pose estimation module is configured to recover from position loss by:
detecting that robot has been relocated to an unknown position by identifying at least one of:
inconsistency between predicted landmark observations and actual observations,
complete loss of landmark detections in expected locations,
explicit indication that robot was powered off and moved, or a manual trigger requesting position recovery;
upon detecting position loss, initiating kidnapped robot recovery by:
ceasing to rely on previous pose estimates,
expanding landmark search to a wider field of view or multiple orientations, and
detecting environmental textual labels without position assumptions and matching detected labels against said semantic landmark database;
re-establishing position by:
identifying matching landmarks with known global positions,
computing a new pose estimate from scratch based on observed landmarks,
validating recovered position through consistency checks, and
resuming normal operation with the recovered position estimate;
performing recovery autonomously without requiring:
human intervention to specify new position,
manual driving to a known location,
restart of the entire system, or re-initialization of a landmark map,
wherein kidnapped robot recovery enables fault tolerance and resilience to position loss events including power cycles, manual relocation, or catastrophic tracking failures.

4. The system of claim 1, wherein said semantic landmark database organizes landmarks hierarchically comprising:
zone-level landmarks corresponding to large-scale navigational signs identifying warehouse areas, aisles, or sectors;
aisle-level landmarks corresponding to aisle identifiers visible from multiple positions along corridors; and
shelf-level landmarks corresponding to individual storage location labels identifying specific shelves, bins, or slots,
wherein said pose estimation module:
achieves coarse localization from zone-level landmarks providing approximate position within tens of meters,
achieves medium localization from aisle-level landmarks providing position within several meters,
achieves fine localization from shelf-level landmarks providing position within centimeters,
and wherein observing landmarks from multiple hierarchical levels simultaneously improves localization accuracy and robustness compared to observing landmarks from a single hierarchical level.

5. The system of claim 1, further comprising:
a continuous localization module that estimates robot pose using relative motion sensors comprising at least one of wheel encoders, inertial measurement units, or geometric feature tracking, wherein said continuous localization accumulates drift errors over time and distance; and
wherein said pose estimation module is configured to correct accumulated drift by:
periodically observing landmarks during navigation;
for each observed landmark:
matching textual content to an entry in said semantic landmark database,
retrieving an absolute three-dimensional position of said landmark in a global reference frame,
measuring a current relative position of the landmark with respect to the robot, and
computing a discrepancy between an expected landmark position, as based on a drifted pose, and an actual landmark position from said semantic landmark database;
applying drift corrections by:
updating a robot pose estimate to reduce the discrepancy,
resetting accumulated odometry errors using a landmark-based absolute reference,
weighting corrections based on landmark position uncertainty and observation quality, and
fusing continuous relative estimates with discrete absolute corrections; and
maintaining bounded localization error by:
ensuring landmark observations occur frequently enough to prevent excessive drift,
automatically seeking landmark-rich areas when uncertainty grows, and
limiting a maximum time or distance between landmark corrections,
wherein landmark-based drift correction provides absolute position references that prevent unbounded error growth characteristic of dead reckoning and relative localization methods, enabling accurate long-term navigation without periodic manual position resets.

6. The system of claim 1, wherein said pose estimation module is configured to resolve localization ambiguities by:
when observing a single landmark:
constraining robot position to lie on circle or region around said landmark,
identifying orientation ambiguity when landmark surface normal is unknown,
computing multiple pose hypotheses consistent with single landmark observation,
flagging pose estimate as ambiguous with increased uncertainty;
when observing multiple landmarks simultaneously or sequentially within short time window:
obtaining constraints from each landmark observation,
identifying unique pose that satisfies all landmark constraints,
resolving position ambiguity through geometric triangulation,
resolving orientation ambiguity through relative positions of multiple landmarks,
computing pose estimate with reduced uncertainty compared to single landmark;
actively seeking additional landmarks when ambiguity exists by:
directing sensors toward expected locations of additional landmarks,
moving robot to viewpoints that enable observation of more landmarks,
prioritizing landmark-rich paths during navigation,
delaying critical maneuvers until pose confidence is sufficient;
wherein multiple landmark observations enable precise pose determination while single landmark observations provide approximate position, and wherein system actively manages observation strategy to achieve required localization accuracy for current task.

7. The system of claim 1, wherein said text extraction module is further configured to:
extract a visual appearance descriptor from image regions containing detected textual content, said visual appearance descriptor comprising at least one of: keypoint descriptors, learned image embeddings, color histograms, or geometric properties including at least one of size, aspect ratio, or orientation;
associate said visual appearance descriptor with corresponding landmarks in said semantic landmark database; and
wherein said pose estimation module is configured to:
perform preliminary matching based on textual content,
perform verification matching based on the visual appearance descriptor to distinguish between identical textual labels at different locations,
increase confidence in landmark matches when both textual content and the visual appearance descriptor match, and
reject false matches when textual content matches but the visual appearance descriptor differs beyond a threshold,
thereby enabling disambiguation of duplicate labels and reducing false positive landmark associations.

8. The system of claim 1, further comprising an environmental adaptation module configured to:
detect ambient lighting conditions from said images;
adjust image processing parameters based on detected lighting conditions to maintain text detection performance across varying illumination, wherein said image processing parameters comprise at least one of illumination normalization, contrast enhancement, deblurring, perspective correction, or binarization parameters for text segmentation;
detect degraded or damaged labels by identifying at least one of:
reduced text recognition confidence scores,
incomplete character detection,
visual damage indicators in label regions; and
when a degraded label is detected:
increase position uncertainty for landmarks associated with said degraded label,
require additional corroborating observations before accepting pose estimates based on said degraded label,
flag said landmark for human verification or re-mapping, and
wherein said environmental adaptation enables reliable localization despite varying lighting conditions and label degradation over time.

9. The system of claim 1, wherein said pose estimation module is configured to detect and recover from localization tracking failures by:
monitoring localization health through metrics comprising at least one of:
rate of successful landmark detections,
consistency of pose estimates across consecutive updates,
magnitude of pose corrections from landmark observations,
geometric consistency when observing multiple landmarks, or innovation in sensor measurements compared to predictions;
detecting localization failure when said health metrics indicate at least one of:
pose estimates diverging or oscillating,
expected landmarks not being detected,
landmark observations contradicting a current pose estimate, or
uncertainty exceeding an acceptable threshold;
upon detecting failure, performing localization reset by:
discarding a previous pose estimate,
initiating global re-localization using landmark observation without position assumptions,
searching for distinctive landmarks across an expanded search region, and
computing a new pose estimate from detected landmarks without relying on the discarded pose estimate;
validating recovered localization by:
confirming consistency of multiple landmark observations with the recovered pose,
requiring a higher confidence threshold before accepting a reset estimate,
performing sanity checks against facility geometry and operational constraints, and
gradually transitioning from the reset estimate to continuous tracking; and
maintaining safe operation during reset by:
reducing or halting robot motion during re-localization,
activating collision avoidance, and
flagging a localization failure for operator review if autonomous reset fails,
wherein localization reset capability enables recovery from catastrophic tracking failures without system restart or manual intervention, providing resilience against sensor anomalies, dynamic occlusions, environmental changes, or software glitches.

10. The system of claim 1, wherein said semantic landmark database maintains observation metadata for each landmark comprising at least one of:
timestamps of first observation and most recent observation, an observation count, confidence scores associated with one or more observations, viewing geometry associated with one or more observations including at least one of view angle or sensor-to-landmark distance, or an uncertainty estimate for the landmark position; and
wherein said pose estimation module is configured to:
weight landmark contributions to pose estimates based at least in part on said observation metadata by increasing weight for landmarks having higher confidence and lower position uncertainty and decreasing weight for landmarks having lower confidence or higher position uncertainty;
detect relocated or removed labels by at least one of:
identifying landmarks not observed for an extended time period despite robot traversal through an expected observation region, or
detecting systematic position shifts in landmark observations over time; and
detect newly added labels by:
identifying textual content with no matching entry in said semantic landmark database,
requiring multiple consistent observations before permanently adding a new landmark, and
validating new landmark positions through triangulation from multiple viewpoints, and
wherein maintaining said observation metadata enables map maintenance and adaptation to environment changes without manual intervention.

11. The system of claim 1, further comprising a semantic task interface configured to:
receive task specifications from a warehouse management system or a human operator, said task specifications comprising textual identifiers corresponding to target locations;
translate a textual identifier to a spatial coordinate by querying said semantic landmark database for a matching semantic landmark and retrieving a three-dimensional position associated with the matching semantic landmark; and
provide said spatial coordinate to navigation control to execute navigation to the target location,
wherein said semantic task interface enables task specification using human-readable identifiers corresponding to pre-existing environmental labels.

12. The system of claim 1, wherein said bootstrapping module enables rapid deployment of additional robots by:
providing an initial landmark map to a newly deployed robot comprising:
text-annotated landmarks observed by previously operating robots,
landmark position estimates,
landmark reliability metrics;
enabling new robot to:
immediately localize upon startup using pre-existing landmark map without exploration phase,
begin productive operation without delay for mapping,
contribute refinement observations to improve shared map accuracy;
handling map version synchronization by:
tracking map version numbers,
detecting when robot operates with outdated map,
updating robot maps incrementally to avoid operation interruption,
resolving conflicts between robot local updates and shared map updates;
accelerating convergence by:
prioritizing exploration of unmapped regions when expanding coverage,
exploiting known landmark distribution to plan efficient mapping trajectories,
sharing real-time observations to immediately benefit all robots,
wherein fleet expansion is simplified and new robots achieve full productivity immediately rather than requiring individual mapping periods, reducing deployment time and cost.

13. A method for autonomous mobile robot localization in industrial environments, the method comprising:
during autonomous operation of a mobile robot through an environment comprising textual labels on environmental features:
acquiring image data and spatial data of said environment using onboard sensors;
extracting textual content from said image data, wherein said textual content represents existing labels, signs, or markings not installed specifically for robotic navigation;
determining spatial positions associated with said extracted textual content;
maintaining a database of semantic landmarks, each semantic landmark associating textual content with a spatial position;
upon detecting textual content:
matching said detected textual content against semantic landmarks in said database,
when a match is found, computing robot pose using known position of matched landmark and observed relative position,
when no match is found, adding a new semantic landmark to said database;
providing computed robot pose to navigation control; and
performing said acquiring, extracting, determining, maintaining, matching, and providing continuously and autonomously during robot operation,
wherein said method enables localization using pre-existing environmental features without requiring human intervention to specify robot starting position or install localization infrastructure.

14. The method of claim 13, further comprising performing global localization by:
detecting textual content on environmental features without prior knowledge of robot position;
matching detected textual content against semantic landmarks in said database having known positions in a global coordinate frame;
upon finding at least one match:
determining spatial relationship between robot and matched landmark from sensor measurements,
computing robot pose in said global coordinate frame based on known landmark position and measured spatial relationship,
when multiple landmarks are detected, improving pose accuracy through geometric constraints from multiple matches;
establishing absolute position reference enabling:
initialization of navigation without manual position entry,
recovery from position loss events,
correction of accumulated drift in relative localization,
wherein global localization capability eliminates dependency on continuous pose tracking from known starting points and enables autonomous position determination using pre-existing environmental text features.

15. A method for autonomous robot recovery from position loss, the method comprising:
detecting that a mobile robot has lost knowledge of its position in an environment due to at least one of: power cycle, manual relocation, tracking failure, or extended loss of sensor data;
upon detecting position loss:
capturing images of said environment using onboard camera,
extracting textual content from environmental features comprising labels, signs, or markings not installed specifically for robot navigation,
determining spatial positions associated with detected textual content using depth sensing,
comparing detected textual content against landmark database storing known text-position associations;
upon finding matching landmarks:
computing robot pose from geometric relationship between robot and observed landmarks with known positions,
validating computed pose through consistency checks,
reinitializing robot localization system with computed pose;
resuming autonomous operation without requiring:
human intervention to specify position,
manual movement to known location,
system restart or recalibration,
wherein autonomous recovery from position loss events enables resilient operation and reduces operational downtime.

16. The method of claim 14, further comprising:
adapting to environmental variations by applying at least one preprocessing operation to the captured images prior to extracting said textual content, said preprocessing operation selected from illumination normalization, contrast enhancement, deblurring, or perspective correction;
performing multi-scale processing to detect text at different sizes; and
validating detections by at least one of:
requiring temporal consistency across multiple frame observations,
verifying geometric consistency between depth and image data,
cross-checking against expected label patterns and formats, or filtering spurious detections based on confidence thresholds,
wherein said adapting, performing, and validating enable reliable recovery across varying lighting conditions, label types, fonts, sizes, orientations, and states of degradation.

17. The method of claim 13, further comprising correcting accumulated localization drift by:
operating robot using relative localization methods that accumulate errors over time including at least one of: wheel odometry, inertial measurement, or geometric feature tracking;
periodically observing environmental landmarks during navigation;
for each landmark observation:
matching observed textual content to database entry with known absolute position,
computing position discrepancy between current pose estimate and landmark-based position,
applying correction to pose estimate using landmark as absolute reference,
resetting accumulated odometry errors;
maintaining bounded localization error by ensuring landmark observations occur with sufficient frequency to prevent excessive drift accumulation,
wherein landmark-based drift correction enables long-duration autonomous operation without unbounded error growth or need for periodic manual position resets.

18. The method of claim 13, when executed by multiple robots in a fleet, further comprising:
sharing newly discovered semantic landmarks among said robots;
aggregating observations of identical textual content from different viewpoints to improve landmark position estimates;
detecting conflicting observations when different robots report different positions for the same textual content;
resolving conflicts by applying statistical fusion based on at least one of observation confidence, viewing geometry, or calibration quality; and
synchronizing updates to said database of semantic landmarks across said fleet, including distributing incremental map updates and tracking map versions,
wherein multi-robot coordination improves mapping speed, accuracy, and coverage beyond capabilities of individual robots operating independently.

19. A multi-robot localization system comprising:
a plurality of autonomous mobile robots each comprising sensors for image acquisition and spatial sensing;
a shared semantic landmark repository accessible by all robots in said plurality, said repository storing text-annotated landmarks observed by any robot;
a collaborative mapping module configured to:
receive landmark observations from multiple robots,
aggregate observations of identical textual content from different viewpoints,
improve landmark position estimates through multi-robot statistical fusion,
detect and resolve inconsistencies when different robots report conflicting positions for same textual identifier,
identify newly added or relocated labels based on change patterns across robot observations,
distribute updated landmark data to said plurality of robots; and
a bootstrapping module configured to enable a newly deployed robot to:
download pre-existing landmark map built by other robots,
localize immediately upon startup using said pre-existing landmark map without manual initialization,
contribute additional landmark observations to refine map accuracy,
wherein collaborative observation from multiple robots improves landmark position accuracy beyond what any single robot could achieve, and wherein new robots benefit from prior mapping effort without duplicating exploration.

20. A non-transitory computer-readable storage medium storing instructions that, when executed by processing hardware of an autonomous mobile robot system, cause said system to:
process sensor data to identify textual information in an environment;
associate identified textual information with spatial positions;
build and maintain a semantic map comprising text-position associations;
determine robot pose by matching observed textual information against said semantic map;
adapt localization behavior based on environmental conditions including at least one of:
degrading position accuracy estimates when observing distant or degraded labels,
increasing confidence in position estimates when multiple independent landmarks are simultaneously observed,
triggering re-localization when accumulated pose uncertainty exceeds a threshold,
adjusting processing parameters based on ambient lighting conditions; and
interface with task management systems by:
receiving task specifications referencing textual identifiers,
translating textual identifiers to spatial coordinates using said semantic map,
executing navigation to spatial coordinates corresponding to specified textual identifiers,
wherein said instructions enable localization and task execution using human-readable environmental labels without requiring dedicated localization infrastructure.
